(19) United States
(12) Patent Application Publication
(10) Pub. No.: US 2021/0182893 A1
(43) Pub. Date: Jun. 17, 2021

(54) INFORMATION PROCESSING APPARATUS AND INFORMATION PROCESSING METHOD

(71) Applicant: FeliCa Networks, Inc., Tokyo (JP)

(72) Inventor: Takayuki HIRANO, Chiba (JP)

(73) Assignee: FeliCa Networks, Inc., Tokyo (JP)

(21) Appl. No.: 17/257,961

(22) PCT Filed: Jul. 22, 2019
(86) PCT No.: PCT/JP2019/028634

§ 371 Date: Jan. 5, 2021

(30) Foreign Application Priority Data
Jul. 30, 2018 (JP) 2018-142336

(51) Int. Cl. G06Q 30/02; G06K 7/10

(52) U.S. Cl. CPC G06Q 30/0222; G06K 7/10297

(57) ABSTRACT

The information processing apparatus includes a receiving unit and a generating unit. The receiving unit receives purchase information generated on the basis of a payment operation using a user terminal for purchasing a target object, from the user terminal. The generating unit generates, on the basis of the received purchase information and predetermined rule information regarding giving of a reward, reward information regarding the reward depending on purchase of the target object.

### TECHNICAL FIELD

The present technology relates to an information processing apparatus and an information processing method that can be applied to giving of a reward depending on purchase of a commodity or the like.

### BACKGROUND ART

In recent years, services for giving various rewards to purchase of commodities or the like have been developed. For example, in a system for giving a regional specific point in a regional currency using an electronic medium described in Patent Literature 1, a general-purpose area and a specific regional area are respectively set. The point giving rate is set as appropriate for each set area. Accordingly, flexible operation can be performed for each region and commerce activation is achieved (paragraphs [0015] and [0030], FIG. 1, and the like of Patent Literature 1).

### CITATION LIST

### Patent Literature

Patent Literature 1: Japanese Patent Application Laid-open No. 2012-64005

### DISCLOSURE OF INVENTION

### Technical Problem

As described above, it is desirable to provide a technology capable of performing flexible operation for giving a reward depending on purchase of a commodity or the like.

In view of the above-mentioned circumstances, it is an object of the present technology to provide an information processing apparatus and an information processing method that are capable of realizing flexible operation for giving a reward depending on purchase of a commodity or the like.

### Solution to Problem

In order to accomplish the above-mentioned object, an information processing apparatus according to an embodiment of the present technology includes a receiving unit and a generating unit.

The receiving unit receives purchase information generated on the basis of a payment operation using a user terminal for purchasing a target object, from the user terminal.

The generating unit generates, on the basis of the received purchase information and predetermined rule information regarding giving of a reward, reward information regarding the reward depending on purchase of the target object.

In this information processing apparatus, the purchase information generated on the basis of the payment operation using the user terminal for purchasing the target object is received from the user terminal. On the basis of the received purchase information and the predetermined rule information regarding giving of the reward, the reward information regarding the reward depending on purchase of the target object is generated. Accordingly, it is possible to realize flexible operation for giving a reward depending on purchase of a commodity or the like.

The payment operation may include a tap interaction.

The purchase information may include payment information regarding the purchase of the target object.

The purchase information may include at least one of a time at which the payment operation is performed or a position at which the payment operation is performed.

The user terminal may be capable of performing at least one of communication using a code image or a near field communication (NFC).

The information processing apparatus may further include a sending unit that sends the generated reward information to the user terminal.

The information processing apparatus may further include a receiving unit that receives the rule information set by a business operator.

The rule information may include at least one of a target object that is a reward giving target, a purchase amount that is a reward giving target, a purchase period that is a reward giving target, or a purchase position that is a reward giving target.

The information processing apparatus may further include a storage unit that stores a history of the received purchase information. In this case, the generating unit may generate the reward information on the basis of the stored history of the purchase information.

The information processing apparatus may further include a receiving unit that receives the rule information set by a business operator. In this case, the receiving unit may receive the rule information at a timing after the history of the purchase information is stored in the storage unit.

The information processing apparatus may further include a storage unit that stores a history of the received purchase information. In this case, the generating unit may generate analysis information regarding the purchase of the target object on the basis of the stored history of the purchase information.

An information processing method according to an embodiment of the present technology is an information processing method performed by a controller that is an information processing apparatus, the information processing method including receiving purchase information generated on the basis of a payment operation using a user terminal for purchasing a target object, from the user terminal.

On the basis of the received purchase information and predetermined rule information regarding giving of a reward, reward information regarding the reward depending on purchase of the target object is generated.

An information processing apparatus according to another embodiment of the present technology is an information processing apparatus that is usable by a user, the information processing apparatus including a generating unit, a sending unit, and a receiving unit.

The generating unit generates purchase information on the basis of a payment operation using the information processing apparatus for purchasing a target object of the user.

The sending unit sends the generated purchase information.

The receiving unit receives reward information regarding the reward depending on purchase of the target object, the reward information being generated on the basis of the sent purchase information.

The payment operation may include a tap interaction.

The purchase information may include payment information regarding the purchase of the target object.

The information processing apparatus may further include an obtaining unit that obtains, on the basis of the payment operation, at least one of a time at which the payment operation is performed or a position at which the payment operation is performed. In this case, the purchase information may include the obtained at least one of the time at which the payment operation is performed or the position at which the payment operation is performed.

The information processing apparatus may further include a communication unit communicable with an external apparatus. In this case, the payment operation may include an operation of bringing the information processing apparatus close to the external apparatus for communicating with the external apparatus.

The communication unit may be capable of performing at least one of communication using a code image or a near field communication (NFC).

The sending unit may send the purchase information in accordance with generation of the purchase information in real time.

The sending unit may collectively send the generated purchase information at a predetermined timing.

The information processing apparatus may include a display unit capable of displaying the received reward information.

An information processing method according to another embodiment of the present technology is an information processing method that is performed by a controller in an information processing apparatus, the information processing method including generating purchase information on the basis of a payment operation using the information processing apparatus for purchasing a target object of the user.

The generated purchase information is sent.

Reward information regarding the reward depending on purchase of the target object, the reward information being generated on the basis of the sent purchase information is received.

### Advantageous Effects of Invention

As described above, in accordance with the present technology, it is possible to realize flexible operation for giving a reward depending on purchase of a commodity or the like. It should be noted that the effects described here are not necessarily limitative and any effect described in the present disclosure may be provided.

### BRIEF DESCRIPTION OF DRAWINGS

FIG. 1 A schematic diagram showing a configuration example of a user return system according to an embodiment.

FIG. 2 A block diagram showing a hardware configuration example of a server apparatus.

FIG. 3 A block diagram showing a software configuration example of the server apparatus.

FIG. 4 A block diagram showing a functional configuration example of a user terminal.

FIG. 5 A sequence diagram showing a specific processing example of the user return system.

FIG. 6 A sequence diagram for more specifically describing the sequence shown in FIG. 5.

FIG. 7 A schematic diagram showing an operation example of the server apparatus.

FIG. 8 A flowchart showing a specific processing example of reward information generation.

FIG. 9 A flowchart showing an example of reward information generation for past purchases.

FIG. 10 A diagram showing a specific example of rule information.

### MODE(S) FOR CARRYING OUT THE INVENTION

Hereinafter, embodiments according to the present technology will be described with reference to the drawings.

[User Return System]

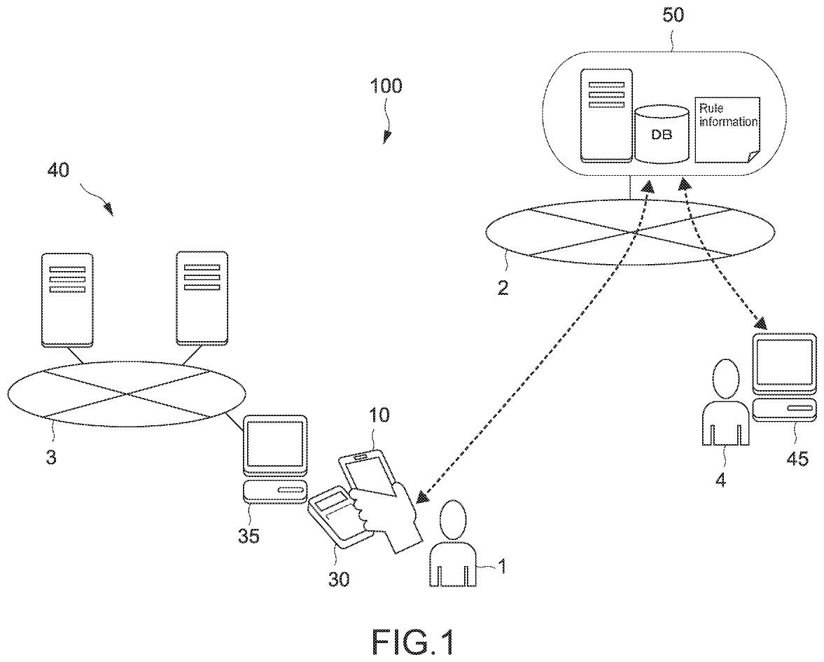

FIG. 1 is a schematic diagram showing a configuration example of a user return system 100 according to an embodiment of the present technology. The user return system 100 includes a user terminal 10, a reader/writer 30, a point of sale (POS) apparatus 35, a payment system 40, an business operator terminal 45, and a server apparatus 50.

The user terminal 10 is a terminal that can be used by the user 1. In this embodiment, the user terminal 10 is used for purchasing an object such as a commodity. As the user terminal 10, for example, a portable terminal such as a smartphone and a tablet terminal is used. Additionally, any other terminal such as a game console, personal digital assistants (PDA), and a portable AV player may be used as the user terminal 10.

The user terminal 10 has a communication function and is communicable with the reader/writer 30 or the like. For example, the user terminal 10 is equipped with an IC chip and an antenna capable of performing contactless communication with the reader/writer 30 in a narrow range of about 10 cm.

In this embodiment, communication (hereinafter, referred to as NFC communication) according to a short-range radio standard (near field communication: NFC) having an RF carrier frequency of 13.56 MHz and a communication speed of 100 to 400 Kbps can be performed.

Examples of the communication method of the NFC communication can include FeliCa (registered trademark). As a matter of course, the present technology is not limited to this communication method, and can also be applied to NFC communication according to other communication methods.

For example, the user 1 brings the user terminal 10, which is set in a state in which electronic money payment can be performed, close to the reader/writer 30. The NFC communication is performed between the user terminal 10 and the reader/writer 30, such that the electronic money payment is performed. Accordingly, an object such as a commodity can be purchased.

It should be noted that as an IC card capable of electronic money payment using the NFC communication, many types of IC cards are used. Various business operators such as transportation business operators issue IC cards individually and the electronic money payment can be performed using each IC card. In this embodiment, by using the user terminal 10, electronic money payment using each of different types of IC cards (plurality of types of electronic money) can be performed.

Further, in this embodiment, it is possible to perform communication with the reader/writer 30 or the like using a code image such as a QR code (registered trademark). For example, the user 1 starts a predetermined application for purchasing a commodity or the like and displays a code image on a display unit of the user terminal 10. The user terminal 10 on which the code image is displayed is brought close to the reader/writer 30 to read the code image. Accordingly, payment using the code image such as QR code payment can be performed.

Further, the user terminal 10 is capable of generating purchase information and sending the purchase information to the server apparatus 50 via a network 2. Further, the user terminal 10 is capable of receiving reward information generated by the server apparatus 50 via the network 2. The purchase information and the reward information will be described later in detail.

The network 2 is constructed by the Internet, a wide area communication network, or the like, for example. Otherwise, a wide area network (WAN), a local area network (LAN), or the like may be used and a protocol for constructing the network 2 is not limited.

The reader/writer 30 has an antenna and is capable of performing contactless communication with the user terminal 10. In this embodiment, the reader/writer 30 is capable of performing NFC communication with the user terminal 10.

Further, the reader/writer 30 is capable of reading the code image displayed on the user terminal 10 and obtaining information stored in the code image. A plurality of types of code images such as a QR code and a barcode may be configured to be each readable.

Therefore, in this embodiment, it is possible to perform both the NFC communication and the communication using the code image between the user terminal 10 and the reader/writer 30.

The POS apparatus 35 includes a register capable of processing purchase of commodities. For example, the POS apparatus 35 sends information about sales and inventory of the commodities purchased by the user 1 to a host computer (not shown) or the like and performs printing of receipts and the like. In this embodiment, the POS apparatus 35 generates payment information on the basis of a payment operation.

The payment system 40 is a computer connected to the POS apparatus 35 via a network 3. The payment system 40 receives the payment information generated by the POS apparatus 35. Further, the payment system 40 is constructed for each business operator that issues IC cards and manages payment information by each type of electronic money.

In this embodiment, the user terminal 10 and the POS apparatus 35 communicate with each other, such that the payment information of the user terminal 10 can be updated. For example, the amount of electronic money stored in the user terminal 10 is updated to a numerical value obtained by subtracting the price of the commodity. Further, the payment system 40 sends the updated payment information back to the POS apparatus 35.

It should be noted that the type of the network 3 that connects the payment system 40 and the POS apparatus 35 to be communicable is not limited. For example, the network 3 may be constructed in the same protocol as the network 2 used in the server apparatus 50 or may be constructed in a protocol different from that of the network 2. For example, the payment system 40 and the PSO apparatus 35 may be communicably connected to each other via the network 2.

The business operator terminal 45 is a terminal used by a business operator 4. The business operator terminal 45 is communicably connected to the server apparatus 50 via the network 2 and various settings of rule information are registered by the business operator 4. For example, the business operator 4 is capable of registering settings of a point program or the like for allowing a user who purchased specific commodities of 1000 yen or more within the period of September to November to give 10% of the purchase amount as points as a fall campaign.

That is, the business operator 4 is capable of registering the rule information for giving the reward such as points to purchase of specific commodities or the like by the user 1 in the server apparatus 50. The user 1 is given a reward by participating in the rule information set by the business operator 4.

The server apparatus 50 comprehensively controls the user return system 100. For example, the server apparatus 50 generates reward information on the basis of the purchase information sent from the user terminal 10 and the rule information set by the business operator 4 and sends the reward information to the user terminal 10. Further, the server apparatus 50 generates analysis information linked to purchase information of the user 1 and personal information of the user 1 and sends the analysis information to the business operator 4. The reward information and the analysis information will be described later in detail.

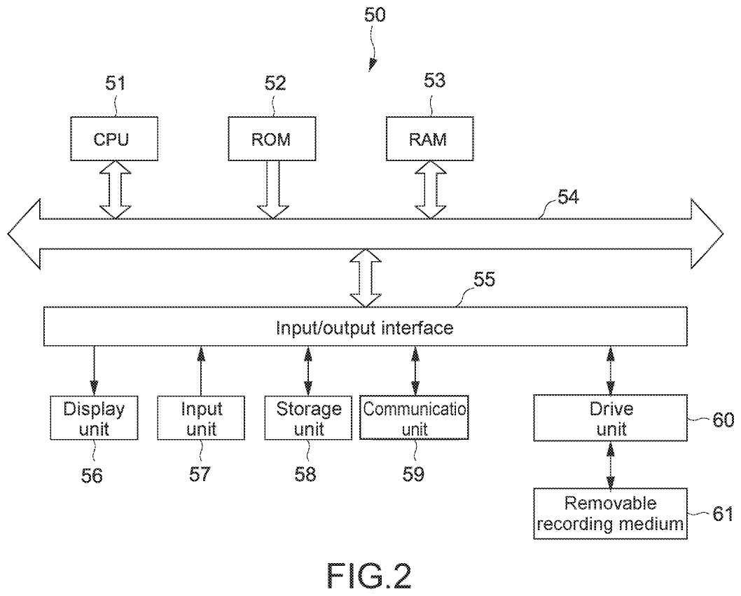

FIG. 2 is a block diagram showing a hardware configuration example of the server apparatus 50 shown in FIG. 1. The server apparatus 50 can be implemented by any computer such as a personal computer (PC).

The server apparatus 50 includes a central processing unit (CPU) 51, a read only memory (ROM) 52, a random access memory (RAM) 53, an input/output interface 55, and a bus 54 that connects them to one another. A display unit 56, an input unit 57, a storage unit 58, a communication unit 59, a drive unit 60, and the like are connected to the input/output interface 55.

The display unit 56 is, for example, a display device using liquid crystals, electro-luminescence (EL), or the like. The input unit 57 is, for example, a keyboard, a pointing device, a touch panel, or another operation device. In a case where the input unit 57 includes a touch panel, the touch panel may be integrated with the display unit 56.

The storage unit 58 is a non-volatile storage device, and is, for example, a hard disk drive (hard disk drive), a flash memory, or another solid-state memory. The drive unit 60 is, for example, a device capable of driving a removable recording medium 61 such as an optical recording medium and a magnetic recording tape.

The communication unit 59 is a modem, a router, or another communication device connectable to a LAN, a WAN, or the like for communicating with other devices. The communication unit 59 may perform wired communication or may perform wireless communication. The communication unit 59 is often used separately from the server apparatus 50.

In this embodiment, the communication unit 59 enables communication with other devices via the network 2 to be performed. It should be noted that in this embodiment, the communication unit 59 corresponds to a sending unit that sends the generated reward information to the user terminal.

Information processing by the server apparatus 50 having the above-mentioned hardware configuration is realized in cooperation of software stored in the storage unit 58, the ROM 52, or the like and hardware resources of the server apparatus 50. Specifically, an information processing method according to the present technology is realized by loading a program stored in the ROM 52 or the like and configuring the software into the RAM 53 and executing the program.

The program is installed in the server apparatus 50, for example, through the recording medium 61. Alternatively, the program may be installed in the server apparatus 50 via a global network or the like. Additionally, any non-transitory computer readable storage medium may be used.

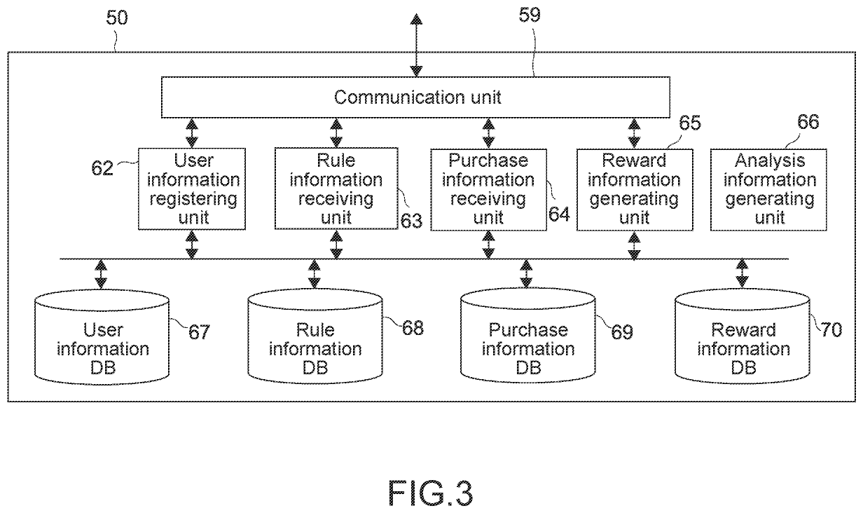

FIG. 3 is a block diagram showing a software configuration example of the server apparatus 50 according to this embodiment. In such a manner that the CPU 51 shown in FIG. 2 executes a predetermined program, a user information registering unit 62, a rule information receiving unit 63, a purchase information receiving unit 64, a reward information generating unit 65, and an analysis information generating unit 66, which are software blocks, are realized. It should be noted that in order to realize each block, dedicated hardware such as an integrated circuit (IC) may be used as appropriate. Further, FIG. 3 shows a user information DB 67, a rule information DB 68, a purchase information DB 69, and a reward information DB 70 constructed in the storage unit 58.

The user information registering unit 62 registers user information regarding the user 1 using the user terminal 10. For example, the user information includes the personal information of the user 1, such as a user ID, a password, a gender, an age, an address, and the like. Further, the user information includes which rule information the user 1 is participating in and participation information including a date on which the user 1 was registered in the rule information.

The user information registered by the user information registering unit 62 is stored in the user information DB 67. It should be noted that the type of information registered as the user information is not limited and may be arbitrarily set. For example, for the personal information of the user 1, items required to register, optional items to register, and the like may be set.

The rule information receiving unit 63 receives the rule information for giving the reward, the rule information being set by the business operator 4. The rule information received by the rule information receiving unit 63 is stored in the rule information DB 68. It should be noted that in this embodiment, the rule information receiving unit 63 corresponds to a receiving unit that receives the rule information set by a business operator.

The purchase information receiving unit 64 receives the purchase information generated by the user terminal 10. The purchase information is information generated on the basis of a payment operation in which the user 1 uses the user terminal 10 for purchasing a commodity or the like. The purchase information received by the purchase information receiving unit 64 is stored in the purchase information DB 69.

It should be noted that in this embodiment, a history of the purchase information is stored in the purchase information DB 69. The history of the purchase information is information that summarizes purchase information generated when the user 1 purchased an object such as a commodity in the past. For example, purchase information of the user 1, which was generated during the past three years, is stored as the history. It should be noted that the period and the number of times for storing the history of the purchase information are not limited.

The reward information generating unit 65 generates reward information regarding a reward depending on the purchase of the user 1 on the basis of the purchase information of the user 1 and the rule information in which the user 1 is participating. The reward information generated by the reward information generating unit 65 is stored in the reward information DB 70. It should be noted that in this embodiment, the reward information generating unit 65 corresponds to a generating unit that generates, on a basis of the received purchase information and predetermined rule information regarding giving of a reward, reward information regarding the reward depending on purchase of the target object.

The analysis information generating unit 66 generates the analysis information regarding the purchase of the object on the basis of the history of the purchase information stored in the purchase information DB 69.

In this embodiment, the server apparatus 50 functions as an information processing apparatus according to the present technology.

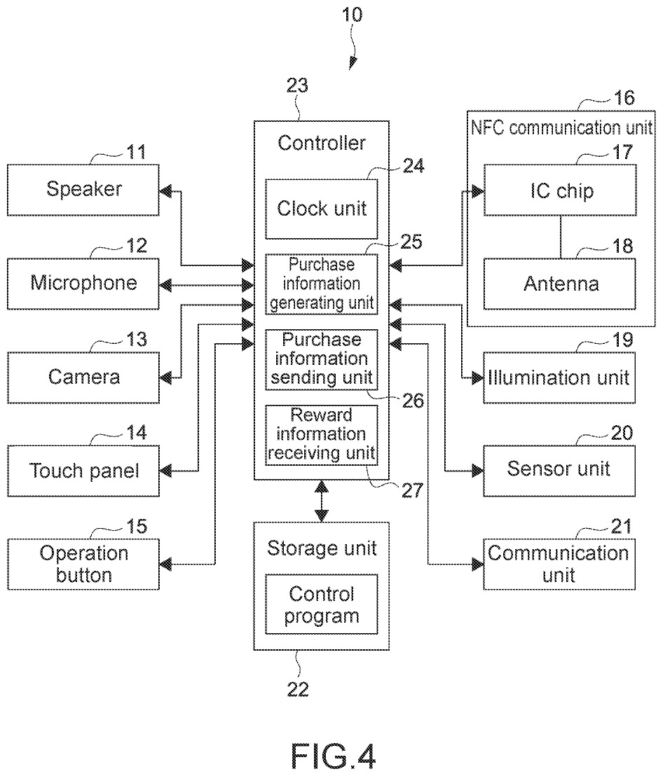

FIG. 4 is a block diagram showing a functional configuration example of the user terminal 10. The user terminal 10 includes a speaker 11, a microphone 12, a camera 13, a touch panel 14, an operation button 15, an NFC communication unit 16, an illumination unit 19, a sensor unit 20, a communication unit 21, a storage unit 22, and a controller 23.

The speaker 11 is capable of outputting a sound. The speaker 11 outputs, for example, voice guidance, an alarm sound, and the like.

The microphone 12 is used for calling, inputting instructions by voice, collecting ambient sounds, and the like.

The camera 13 is capable of capturing images of the user and the surroundings. As the camera 13, for example, a digital camera including an image sensor such as a complementary metal-oxide semiconductor (CMOS) sensor and a charge coupled apparatus (CCD) sensor is used.

The touch panel 14 functions as a display unit and is capable of displaying various images and GUIs. Further, the touch panel 14 is capable of receiving a touch operation by the user. For example, the user is capable of displaying any image such as a code image on the touch panel 14 through the touch panel 14.

Further, the touch panel 14 is capable of displaying reward information given to the user 1. In this embodiment, the contents of the rule information in which the user 1 is participating, the reward information already given to the user 1, and the like are displayed. It should be noted that in this embodiment, the touch panel 14 corresponds to a display unit capable of displaying the received reward information.

The operation button 15 is provided to perform an operation different from the operation performed through the touch panel 14, such as an power on/off operation, for example.

The NFC communication unit 16 includes an IC chip 17 and an antenna 18. The IC chip 17 is an integrated circuit that realizes various functions associated with the NFC communication. The IC chip 17 is capable of performing NFC communication with the reader/writer 30 via the antenna 18.

Examples of the circuit in which the IC chip 17 is integrated can include a demodulation circuit or a regulator, a load modulation circuit for selectively performing load modulation including a load resistor and a switching circuit, a processing circuit for controlling various types of data processing and load modulation, a memory element capable of storing data, and the like. Further, the IC chip 17 may further include a carrier detection circuit that generates a rectangular detection signal for detecting reception of a carrier wave. Additionally, any other configuration may be employed as the IC chip 17.

The antenna 18 is, for example, a resonant circuit constituted by a coil having a predetermined inductance and a capacitor having a predetermined capacitance and functions as a sending and receiving antenna. In a case where the NFC communication is performed, polling signals, communication packets, and the like sent from the reader/writer 30 are received by the antenna 18. Further, the antenna 18 sends carrier waves, reply packets, and the like.

The illumination unit 19 has a light source such as a light emitting diode (LED) and a laser diode (LD) and is capable of outputting light. For example, by turning on the illumination unit 19, it is possible to illuminate a night road and the like like a light. Further, it is also possible to notify of mail reception or the like by the illumination unit 19.

The sensor unit 20 is capable of detecting a surrounding situation, a state of the user terminal 10, a state of the user 1, and the like. For example, a 9-axis sensor, a GPS, a biometric sensor, and the like are mounted as the sensor unit 20. The 9-axis sensor includes a 3-axis acceleration sensor, a 3-axis gyro sensor, and a 3-axis compass sensor. It is possible to detect the acceleration, angular velocity, and azimuth of the user terminal 10 in three axes by the 9-axis sensor. The GPS obtains information about the current location of the user terminal 10.

The biometric sensor obtains biometric information of the user. For example, a temperature sensor capable of measuring body temperature, a heart rate sensor capable of measuring heart rate, a sweat sensor capable of measuring sweat rate, and the like are provided as the biometric sensor.

The type of the sensor provided as the sensor unit 20 is not limited, and any sensor may be provided. For example, a temperature sensor, a humidity sensor, and the like capable of measuring a temperature, humidity, and the like of the environment where the user terminal 10 is used may be provided. It should be noted that it is also possible to consider the microphone 12 and the camera 13 as parts of the sensor unit 20.

The communication unit 21 is a module for performing, for example, network communication, near-field communication, infrared communication, and the like with other devices. For example, a wireless LAN module such as a Wi-Fi or a communication module such as Bluetooth (registered trademark) is provided. Further, any infrared communication module may be used. It should be noted that it is also possible to consider the NFC communication unit 16 as a part of the communication unit 21. In this embodiment, the communication unit 21 communicates with the server apparatus 30 via the network 2.

The storage unit 22 is a nonvolatile storage device, and, for example, a hard disk drive (HDD) or the like is used. The storage unit 22 stores a control program for controlling the overall operation of the user terminal 10. Further, the storage unit 22 stores data used for performing various types of processing, data generated by various types of processing, and the like. The method of installing the control program and the like in the user terminal 10 is not limited.

The controller 23 controls the operation of each block of the user terminal 10. The controller 23 has a hardware configuration such as a CPU and memories (RAM and ROM) that are necessary for a computer. Various types of processing are performed in such a manner that the CPU loads the control program and the like stored in the storage unit 22, into the RAM and executes the control program and the like.

For example, a programmable logic device (PLD) such as a field programmable gate array (FPGA) and other devices such as an application specific integrated circuit (ASIC) may be used as the controller 23.

In this embodiment, the CPU of the controller 23 performs a program according to this embodiment (for example, an application program), such that a clock unit 24, a purchase information generating unit 25, a purchase information sending unit 26, and a reward information receiving unit 27 are realized as functional blocks, and the information processing method according to this embodiment is performed. It should be noted that in order to realize each block, dedicated hardware such as an integrated circuit (IC) may be used as appropriate.

The clock unit 24 obtains time information. The time information includes information about date/month/year, a day of the week, and a current time. For example, the clock unit 25 is capable of obtaining the time information from the outside via the communication unit 21. As a matter of course, the time information may be generated on the basis of an internal clock. The method of obtaining the time information, the method of calibrating the time information, and the like are not limited, and any method may be used.

In this embodiment, when the payment operation is performed, information about the current location of the user terminal 10 is obtained from the GPS. Further, the clock unit 25 obtains a time at which the payment operation is performed. In this embodiment, the block (not shown) that obtains the position information from the GPS included in the sensor unit 20 and the clock unit 24 correspond to an obtaining unit that obtains at least one of a time at which the payment operation is performed or a position at which the payment operation is performed on the basis of the payment operation.

As a matter of course, when the payment operation is performed, a time at which the communication is performed and position information of the reader/writer 30 may be obtained from the reader/writer 30. In this case, the time at which the communication is performed and the position information of the reader/writer 30 correspond to the time at which the payment operation is performed and the position at which the payment operation is performed. The NFC communication unit 16 functions as an obtaining unit.

The purchase information generating unit 25 generates purchase information on the basis of the user's payment operation using the user terminal 10 for purchasing a commodity or the like 1. It should be noted that in this embodiment, the purchase information generating unit 25 functions as a generating unit.

The purchase information sending unit 26 sends the purchase information generated by the purchase information generating unit 25. In this embodiment, the purchase information sending unit 26 corresponds to a sending unit that sends the purchase information to the server apparatus 50.

The reward information receiving unit 27 receives the reward information generated on the basis of the purchase information sent by the purchase information sending unit 26. In this embodiment, the reward information received by the reward information receiving unit 27 can be displayed on the touch panel 14.

In this embodiment, the user terminal 10 functions as the information processing apparatus according to the present technology.

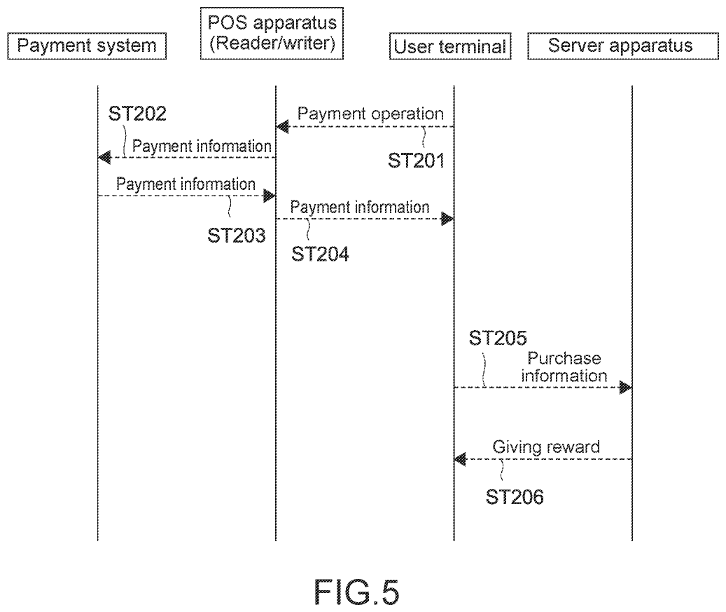

FIG. 5 is a sequence diagram showing a specific processing example of the user return system 100.

The user 1 performs a payment operation by bringing the user terminal 10 close to the reader/writer 30 to enter a range in which the user terminal 10 is communicable with the reader/writer 30 in order to purchase a commodity (Step 201).

The payment operation is an operation using the user terminal 10 for purchasing an object, and includes, for example, a tap interaction, which is an operation for bringing the user terminal 10 close to or in contact with the reader/writer 30. Here, in this embodiment, the tap interaction refers to an operation of bringing the user terminal 10 close to or in contact with the reader/writer 30 in order to perform electronic money payment using the NFC communication. Further, the tap interaction also includes an operation of bringing the user terminal 10 on which the code image is displayed close to or in contact with the reader/writer 30 in order to perform payment using the code image.

As a matter of course, only one of the electronic money payment using the NFC communication or the payment using the code image may be possible. Alternatively, a different payment method may be possible using the user terminal 10. In this case, the operation for performing the payment is a payment operation using the user terminal 10 for purchasing the object.

It should be noted that as the payment operation, an operation different from the operation of bringing the user terminal 10 close to the reader/writer 30 may be performed. For example, the payment operation can also include an operation of accessing a website through which commodity purchase or the like can be requested and purchasing the commodity.

In this embodiment, the purchase information receiving unit 64 corresponds to a receiving unit that receives reward information regarding the reward depending on purchase of the target object, the reward information being generated on the basis of the sent purchase information.

In Step 202, the POS apparatus 35 in cooperation with the reader/writer 30 generates payment information on the basis of the payment operation and sends the payment information to the payment system 40 (Step 202). The payment information is information obtained when the commodity or the like is paid by electronic money. For example, the price of the commodity, a payment type indicating which electronic money was used for payment, a user who owns the electronic money, and the like can be cited.

The payment system 40 receives the payment information from the POS apparatus 35 and updates the received payment information. The updated payment information is sent back to the POS apparatus 35 (Step 203). The updated payment information is sent back to the user terminal 10 from the POS apparatus 35 through the reader/writer 30 (Step 204).

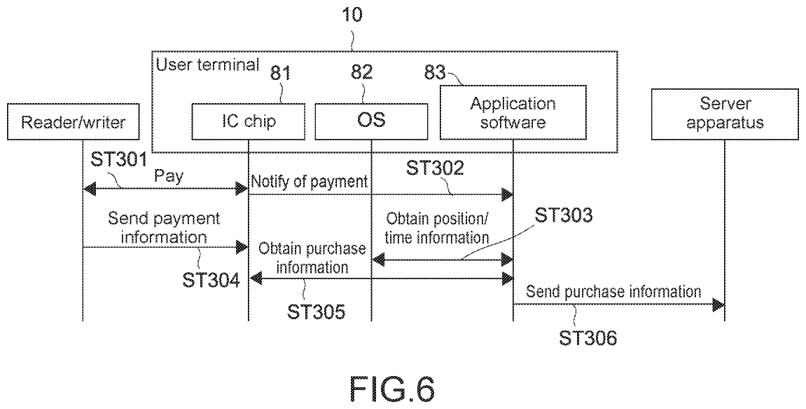

FIG. 6 is a sequence diagram for more specifically describing the sequence of Steps 201 to 205 shown in FIG. 5.

FIG. 6 is a sequence diagram showing a specific example of processing of the user terminal 10.

The user 1 performs a payment operation on the reader/writer 30 with the user terminal 10 in order to purchase the commodity. Accordingly, electronic money payment is performed between an IC chip 81 mounted on the user terminal 10 and the reader/writer 30 (Step 301). As a matter of course, the payment using the code image may be performed.

Further, the IC chip 81 sends a payment notification notifying that the payment was performed to an application software 83 for using the user return system 100 (Step 302). It should be noted that the application software 83 is software performed by an application program according to the present technology and includes respective functional blocks performed by the controller 23 shown in FIG. 4, for example.

When receiving the payment notification from the IC chip 81, the application software 83 obtains the position and time at which the payment of the commodity was performed. That is, the time at which the payment operation was performed and the position at which the payment operation was performed are obtained. It should be noted that in the example shown in FIG. 6, the time at which the payment operation was performed and the position at which the payment operation was performed are obtained in cooperation with an operating system (OS). As a matter of course, the present technology is not limited thereto.

The updated payment information is sent from the POS apparatus 35 to the IC chip 81 of the user terminal 10 through the reader/writer 30 (Step 304). On the basis of the payment information received by the IC chip 81, purchase information is generated by the purchase information generating unit 25 of the application software 83.

The purchase information includes payment information regarding the purchase of the target object such as the commodity. In this embodiment, the payment information updated by the server apparatus 50 is included in the purchase information. The purchase information includes the time at which the payment operation was performed and the position at which the payment operation was performed. The purchase information may include only at least one of the time at which the payment operation was performed or the position at which the payment operation was performed. That is, the purchase information is information including the position of the user 1, the date and time when the purchase was performed, the purchase amount, the user ID, and the payment type.

The purchase information is sent to the server apparatus 50 by the purchase information sending unit 26 of the application software 83 (Step 306). For example, the payment information such as the amount and payment type is read from the IC chip 81. The position information and the time information are obtained from the application software 83 through an OS 82 by using the payment operation as a trigger. Information including the payment information, the position information, and the time information in combination with the user ID is sent to the server apparatus 50 as the purchase information.

The purchase information is sent in real time, for example, in response to generation of the purchase information. Alternatively, the purchase information may be collectively sent at a predetermined timing. The predetermined timing is not limited, and may be arbitrarily set by the user, for example.

As described above, in this embodiment, the purchase information including the payment information, the position information, and the time information is sent from the user terminal 10 to the server apparatus 50 on the basis of the payment operation. That is, the purchase information is collected from the user terminal 10 to the server apparatus 50 in response to user's purchase of the commodity or the like.

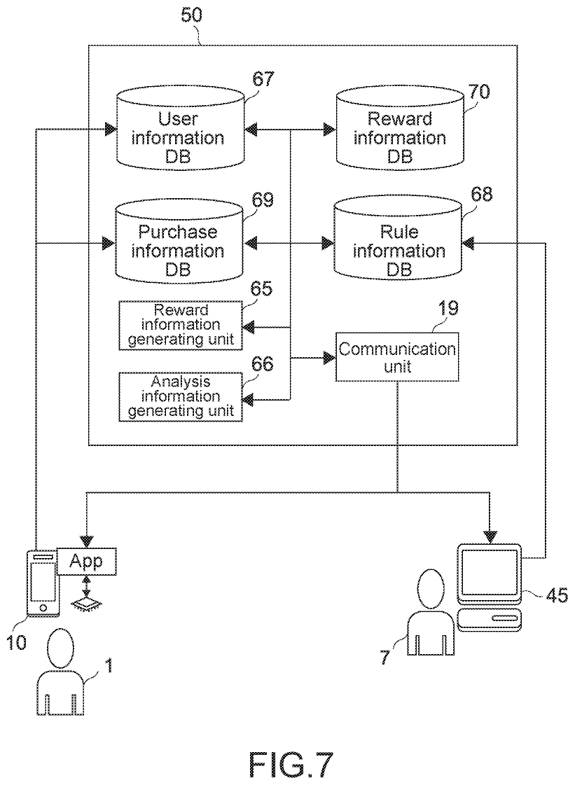

FIG. 7 is a schematic diagram showing an operation example of the server apparatus 50. In FIG. 7, the server apparatus 50 is shown focusing on the user information DB 67, the rule information DB 68, the purchase information DB 69, and the reward information DB 70. The user information registering unit 62, the rule information receiving unit 63, and the purchase information receiving unit 64 are not shown.

As shown in FIG. 7, in this embodiment, the user 1 accepts the use of the payment information and registers the user information. The registered user information is stored in the user information DB 67. Further, the purchase information generated on the basis of the payment operation of the user 1 is received by the server apparatus 50 and stored in the purchase information DB 69.

The rule information is set by the business operator 4 using the business operator terminal 45. The set rule information is stored in the rule information DB 68. The method of setting the rule information by the use of the business operator terminal 45 is not limited. For example, the rule information is set by accessing a webpage for setting rule information in a website operated by the user return system 100. Alternatively, any method may be employed.

The rule information includes, for example, at least one of an object that is a reward giving target, a purchase amount that is a reward giving target, a purchase period that is a reward giving target, and a purchase position that is a reward giving target.

The object that is the reward giving target is information about which commodity or the like should be purchased for earning the reward. For example, it is possible to set that the reward is given in a case where the user 1 purchases a specific commodity. That is, the business operator 4 can set an object that the business operator 4 wishes to make the user 1 purchase as the object that is the reward giving target.

The purchase amount that is the reward giving target is information about how much purchases the user 1 must have made for earning the reward. For example, a setting can be made such that the reward will be given with purchases of 1000 yen or more by the user 1. That is, the reward is given in a case where the purchase amount of the user 1 exceeds a purchase amount set by the business operator 4.

The purchase period that is the reward giving target is information indicating that the reward is to be given in a case where the user 1 purchases a commodity during a specific period. For example, the business operator 4 can make a setting such that the reward will be given in a case where the user 1 purchases a commodity in June.

The purchase position that is the reward giving target is information indicating that the reward is to be given in a case where the user 1 purchases a commodity in a store or region set by the business operator 4. For example, the business operator 4 can make a setting such that the reward will be given to the user 1 in a case where the user 1 makes a purchase at a local government, a shopping mall, or the like.

It should be noted that the rule information is not limited. For example, a setting such that the reward will be given only in a case where a plurality of specific commodities are purchased may be made. Alternatively, for example, a setting such that the user 1 who has made membership registration is given more rewards than the user 1 who has not made membership registration may be made. As a matter of course, the rule information can be any combination of those settings.

As the rule information, a payment method that is the reward giving target may be set. For example, a payment type (e.g., type of IC card or the like) or the like may be set as the rule information. As a matter of course, it is also possible to make a setting such that the reward is to be commonly given for all types of IC cards (all types of electronic money).

It should be noted that the method of registering the rule information is not limited. For example, in order to register the rule information set by the business operator 4 in a platform business operator operating the server apparatus 50, an application for use of the platform using the server apparatus 50 may be submitted or the use fee may be paid out from an account of a back-office.

The reward information generating unit 65 generates reward information regarding a reward depending on the purchase of the user 1 on the basis of the purchase information and the rule information. In this embodiment, in a case where the purchase information stored in the purchase information DB 69 corresponds to the rule information stored in the rule information DB 68, the reward information is generated. The reward information includes, for example, points and coupons for discount or exchangeable for a specific commodity. Additionally, reward information including various rewards depending on the purchase of the commodity or the like may be generated.

Further, rule information may be set to include a plurality of pieces of rule information. For example, it is assumed that rule information A regarding commodity purchase using an IC card A in a store A and rule information B regarding purchase of commodity purchase using an IC card B in a store B are stored. In this case, rule information C including the rule information A and B may be newly set.

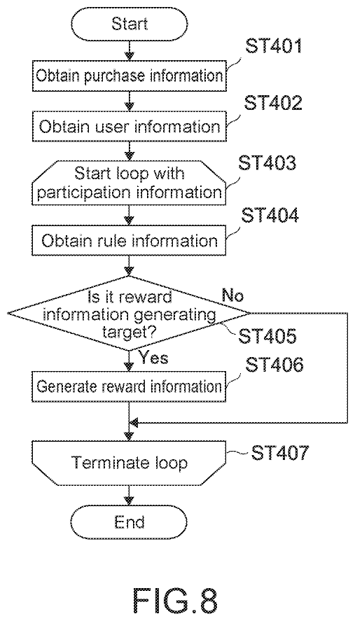

FIG. 8 is a flowchart showing a specific processing example of reward information generation.

The reward information generating unit 65 obtains the purchase information from the purchase information DB 69 (Step 401). Further, the reward information generating unit 65 obtains the user information linked to the purchase information from the user information DB 67 (Step 402).

On the basis of the purchase information and the participation information included in the user information, a loop of Steps 403 to 407 is performed. Specifically, the loop is repeated for all pieces of rule information in which the user 1 is participating and the processing ends in a case where all the loops are performed. It should be noted that the participation information is information including which rule information the user 1 is participating in and a date on which the user 1 was registered in the rule information.

The rule information in which the user 1 is participating is obtained from the rule information DB 68 (Step 404). It is determined whether the purchase information of the user 1 is an object for which the reward information is to be generated (Step 405). In a case where the purchase information is the object for which the reward information is to be generated (Yes in Step 405), the reward information is generated and the loop ends (Steps 406 and 407). In a case where the purchase information is not the object for which the reward information is to be generated (No in Step 405), the loop ends (Step 407).

In this embodiment, it is also possible to give rewards for past purchases retroactively. For example, it is possible to give a reward to a predetermined user such as a purchaser of a new commodity retroactively.

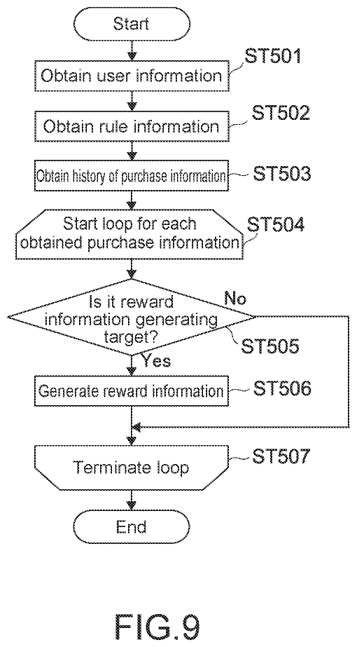

FIG. 9 is a flowchart showing an example of generating reward information for past purchases.

The user information is obtained from the user information DB 67 (Step 501). The rule information is obtained from the rule information DB 68 (Step 502).

The history of the purchase information in which the user 1 has performed purchase is obtained from the purchase information DB 69 (Step 503). The following loop is started for each obtained purchase information (Step 504).

In Step 505, it is determined whether each piece of purchase information included in the history of the purchase information is a target for generating the reward information in the rule information. In a case where the purchase information is the object for which the reward information is to be generated (Yes in Step 505), the reward information is generated and the loop ends (Steps 506 and 507). In a case where the purchase information is not the object for which the reward information is to be generated (No in Step 505), the loop ends (Step 507).

The stored reward information is sent to the user terminal 10 by the communication unit 59. Accordingly, the reward information regarding the reward depending on the purchase of the object, which is generated on the basis of the purchase information, is given to the user 1 in Step 206 of FIG. 5.

As described above, in this embodiment, the analysis information generating unit 66 generates the analysis information on the basis of the user information DB 67 and the purchase information DB 69. The analysis information is information analyzed by linking the registered user information to the purchase information generated at a time at which the user 1 made a purchase. For example, a tendency analysis of the user 1, such as whether the user 1 who purchases a specific commodity more often uses an urban area or a suburb area and what sort of store the user 1 uses is generated. The communication unit 59 sends the generated analysis information to the business operator 4.

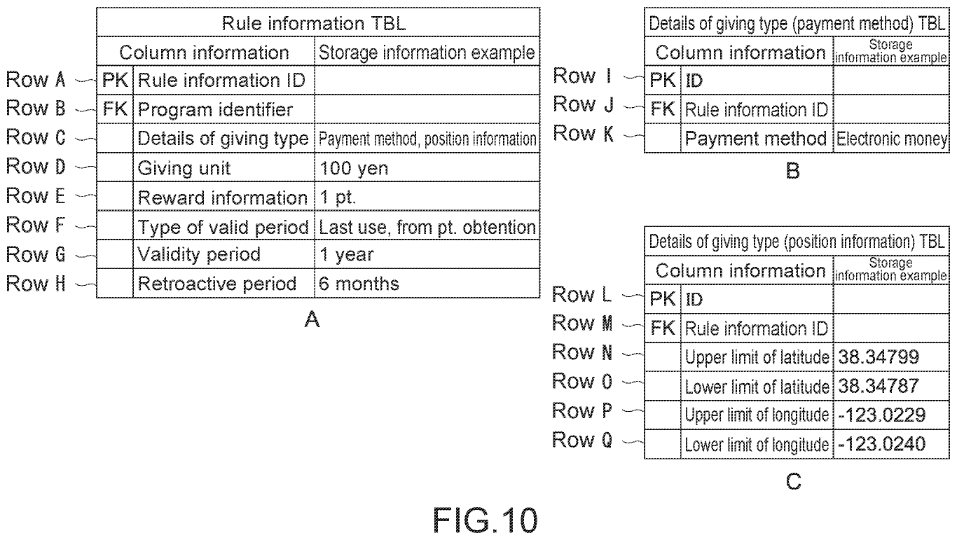

FIG. 10 is a diagram showing a specific example of the rule information.

A primary key (PK) shown in FIG. 10 is a key selected to uniquely identify a row of a rule information TBL (table). In this embodiment, each type of rule information is identified using a rule information ID as the PK.

A foreign key (FK) shown in FIG. 10 are a key associated with other tables. In this embodiment, a program identifier and the rule information ID are set as the FK and it is associated with a table of rows below the row of the FK.

The program identifier is a program for identifying each type of rule information. For example, by reading the rule information ID, the object that is the reward giving target set in the rule information, the purchase amount that is the reward giving target, the purchase period that is the reward giving target, the purchase position that is the reward giving target, and the like are identified.

The row A is the PK whose column information is a row of the rule information ID. Characters in which numbers, Roman alphabet, and the like indicating rule information are combined may be displayed as the stored information example.

The row B is FK whose column information is a row of the program identifier. In this embodiment, the rule information is specified from the rule information ID of the row A, and the rows C to H, which are the settings of the rule information, are referred to.

The row C is a row whose column information is a giving type. The giving type is information indicating to which type of purchase information generated in a case where the user 1 purchases a commodity or the like, the reward information is to be given. As shown in the table of FIG. 10A, an example in which the reward information is to be given is displayed as the stored information example. For example, cash payment is exemplified for the payment method and payment at a specific store is exemplified for the position information or the like.

The row D is a row whose column information is a giving unit. The giving unit is information indicating a reference for giving the reward information on the basis of the purchase information of the user 1. As shown in the table of FIG. 10A, an example in which the reward information is given for every 100 yen is displayed as the stored information example. As a matter of course, the giving unit is not limited, and may be set to 1000 yen or more or the like. Further, the number of purchased commodities may be used as a unit.

The row E is a row whose column information is the reward information. The reward information indicates whether the reward information is to be given in accordance with the giving unit in the row D. For example, reward information of 1 pt. (point) is given for each giving unit as the stored information example.

The row F is a row whose column information is of a validity period type. The validity period type is information indicating a reference of the validity period of the given reward information. For example, the time of last use of specific electronic money or the like, the time when points are obtained, and the like are exemplified as the stored information example.

The row G is a row whose column information is a validity period. The validity period is information indicating a specific period on the basis of the validity period type of the row F. An example in which the validity period is set to one year or less on the basis of the validity period type is displayed as the stored information example.

The row H is a row whose column information is a retroactive period. The retroactive period is information indicating whether or not it is a target to which the reward information is to be given by applying the stored history of the purchase information for a specific period retroactively. For example, a period of 6 months or the like is exemplified as the stored information example. It should be noted that the retroactive period is not limited. For example, a specified past period of from June 1 to Jun. 30, 2017 may be used as the retroactive period.

It should be noted that the column information and the stored information of the rule information TBL are not limited, and may be arbitrarily set. For example, as shown in the tables of FIGS. 10B and C, the payment method and the position information may be set in more detail.

For example, as shown in the tables of FIGS. 10B and C, the user is identified on the basis of the user ID of the column information of row I (L). The rule information in which the specified user 1 is participating is specified by the rule information ID in the column information of row J(M) and the row K (row N to row Q) is referred to.

As shown in the table of FIG. 10B, the payment information, which is the column information of the row K, can be set to give a reward in a case where payment is performed by specific electronic money or credit card, for example.

Further, it is possible to set the upper and lower limits of latitude and the upper and lower limits of longitude, which are the column information of the rows N to Q, as the position information as shown in the table of FIG. 10C. For example, the upper limit of latitude may be set to 38.34799 degrees, the lower limit of latitude may be set to 38.34787 degrees, the upper limit of longitude may be set to −123.0229 degrees, and the lower limit of longitude may be set to −123.0240 degrees or the like.

As a matter of course, the settings of the position information are not limited and may be arbitrarily set. For example, those may be selected from a preset region list or area mapping of the region list and the latitude and longitude may be performed in a map information DB or the like.

As described above, in the server apparatus 50 according to this embodiment, the purchase information generated on the basis of the payment operation using the user terminal 10 for purchasing the object is received from the user terminal 10. On the basis of the received purchase information and predetermined rule information regarding the giving of the reward, the reward information regarding the reward depending on the purchase of the object is generated. Accordingly, it is possible to realize flexible operation for giving a reward depending on purchase of a commodity or the like.

Many of point programs set by business operators return benefits to users on the basis of the fee for the payment amount regardless of a medium such as a mobile device or a card. Therefore, in many cases, many of return programs thereof return benefits to the users for the payment type, specifically, for the use of specific electronic money or a specific credit card.

However, due to diversification of payment methods, it is desirable for stores to promote further purchase by returning benefits for users' use without the need for sticking to payment methods such as electronic money.

On the other hand, in the user return system 100 according to the present technology, the reward information is given to the user by focusing on the purchasing action of the user instead of depending on the fee for the payment amount. For example, a case where a specific store is regarded as one unit or a system capable of returning benefits to a region such as a chain store, a mall, a municipality, and the like is also possible. Accordingly, it is possible to centrally manage all transactions for the user's use actions without depending on the payment type.

For example, when the server apparatus 50 collects the rule information set by the business operator 4 and the purchase information of the user 1 in common, it is possible for the business operator 4 to start a point program for a plurality of types of electronic money without newly constructing a system. Accordingly, it is possible to commonly give points and interchange points. As a result, it is possible to realize flexible operation for giving a reward depending on purchase of a commodity or the like.

By receiving the purchase information linked to the position information, it is possible to give the reward information for payment in a specific region without integrating the payment information of the target stores. Accordingly, the reward information generated from each type of rule information corresponding to each store can be handled as common reward information. As a result, it is possible to realize flexible operation for giving a reward depending on purchase of a commodity or the like.

For example, Chiba city and respective electronic money service providers collaborate to distribute coupons available in Chiba City for payment of 1000 yen or more of electronic money in Chiba City. Further, for example, more points than normal points are given for payment using electronic money in stores operated by the electronic money service providers.

Further, by analyzing the purchase information linked to the user information, it is possible to determine the tendency of the user 1. Accordingly, it is possible to provide a point program in accordance with the analysis information.

For example, in a case where it is found that specific electronic money is more often used in an urban area, it is possible to aim at use by existing users in a suburb area or acquisition of new users living in the suburb area by setting a point program to give double points in a case where payment is performed by the specific electronic money in the suburb area.

Further, for example, in a case where it is found that the use of a specific electronic money in a convenience store is large, it is possible to increase the use of an existing user other than a convenience store by giving more points to the use in a non-convenience store.

Storing the history of the purchase information of the user 1 in the purchase information DB 69 enables points to be given for the purchase information before the user 1 participates in the point program, retroactively. As a result, it is possible to realize flexible operation for giving a reward depending on purchase of a commodity or the like. Further, processing of receiving the rule information at a timing at which the history of the purchase information of the user 1 is stored in the purchase information DB 69 is also possible.

Further, in the user terminal 10 according to this embodiment, the purchase information is generated on the basis of the payment operation using the user terminal 10 which is the user terminal 10 usable by the user 1 and for purchasing the object of the user 1. The generated purchase information is sent. The reward information regarding the reward depending on the purchase of the object, which is generated on the basis of the sent purchase information, is received. Accordingly, it is possible to realize flexible operation for the reward depending on the purchase of the commodity or the like to be given to the user 1 using the user terminal 10.

### OTHER EMBODIMENTS

The present technology is not limited to the above-mentioned embodiment and various other embodiments can be made.

The information processing method according to the present technology can be executed not only in a computer system configured by a single computer but also in a computer system in which a plurality of computers cooperate each other. It should be noted that in the present disclosure, the system means a set of components (such as apparatuses and modules (parts)) and it does not matter whether all of the components are in a single casing. Therefore, a plurality of apparatuses housed in separate casings and connected to one another via a network and a single apparatus having a plurality of modules housed in a single casing are both the system.

Execution of the information processing method according to the present technology by the computer system includes, for example, both a case where receiving of the purchase information generated on the basis of the payment operation using the user terminal for purchasing the target object from the user terminal, generation of the reward information regarding the reward depending on purchase of the target object on the basis of the received purchase information and the predetermined rule information regarding giving of the reward, and the like are performed by a single computer and a case where the respective processes are performed by different computers. Further, performing the respective processes by a predetermined computer includes causing another computer to perform some or all of those processes and obtaining results thereof.

That is, the information processing method according to the present technology can also be applied to a cloud computing configuration in which a single function is shared and commonly processed by a plurality of apparatuses via a network.

The information processing apparatus, the storage unit, the purchase information generating unit, and the like described above with reference to the drawings, the control flow of the control processing unit, and the like are merely one embodiment, and can be arbitrarily modified without departing from the gist of the present technology. That is, any other configurations, algorithms, and the like for carrying out the present technology may be employed.

At least two of the features according to the present technology described above may be combined. In other words, various features described in the respective embodiments may be arbitrarily combined across the embodiments. Further, the various effects described above are merely illustrative, not limitative, and other effects may be provided.

It should be noted that the present technology can also take the following configurations.

(1) An information processing apparatus, including:

a receiving unit that receives purchase information generated on the basis of a payment operation using a user terminal for purchasing a target object, from the user terminal; and

a generating unit that generates, on the basis of the received purchase information and predetermined rule information regarding giving of a reward, reward information regarding the reward depending on purchase of the target object.

(2) The information processing apparatus according to (1), in which

the payment operation includes a tap interaction.

(3) The information processing apparatus according to (1) or (2), in which

the purchase information includes payment information regarding the purchase of the target object.

(4) The information processing apparatus according to (1) to (3), in which

the purchase information includes at least one of a time at which the payment operation is performed or a position at which the payment operation is performed.

(5) The information processing apparatus according to (1) to (4), in which

the user terminal is capable of performing at least one of communication using a code image or a near field communication (NFC).

(6) The information processing apparatus according to (1) to (5), further including

a sending unit that sends the generated reward information to the user terminal.

(7) The information processing apparatus according to (1) to (6), further including

a receiving unit that receives the rule information set by a business operator.

(8) The information processing apparatus according to (1) to (7), in which

the rule information includes at least one of a target object that is a reward giving target, a purchase amount that is a reward giving target, a purchase period that is a reward giving target, or a purchase position that is a reward giving target.

(9) The information processing apparatus according to (1) to (8), further including

a storage unit that stores a history of the received purchase information, in which

the generating unit generates the reward information on the basis of the stored history of the purchase information.

(10) The information processing apparatus according to (9), further including

a receiving unit that receives the rule information set by a business operator, in which

the receiving unit receives the rule information at a timing after the history of the purchase information is stored in the storage unit.

(11) The information processing apparatus according to (1) to (10), further including

a storage unit that stores a history of the received purchase information, in which

the generating unit generates analysis information regarding the purchase of the target object on the basis of the stored history of the purchase information.

(12) An information processing method, including:

by a controller that is an information processing apparatus,

receiving purchase information generated on the basis of a payment operation using a user terminal for purchasing a target object, from the user terminal; and

generating, on the basis of the received purchase information and predetermined rule information regarding giving of a reward, reward information regarding the reward depending on purchase of the target object.

(13) An information processing apparatus that is usable by a user, including:

a generating unit that generates purchase information on the basis of a payment operation using the information processing apparatus for purchasing a target object of the user;

a sending unit that sends the generated purchase information; and

a receiving unit that receives reward information regarding the reward depending on purchase of the target object, the reward information being generated on the basis of the sent purchase information.

(14) The information processing apparatus according to (13), in which

the payment operation includes a tap interaction.

(15) The information processing apparatus according to (13) or (14), in which

the purchase information includes payment information regarding the purchase of the target object.

(16) The information processing apparatus according to (13) or (15), further including

an obtaining unit that obtains, on the basis of the payment operation, at least one of a time at which the payment operation is performed or a position at which the payment operation is performed, in which

the purchase information includes the obtained at least one of the time at which the payment operation is performed or the position at which the payment operation is performed.

(17) The information processing apparatus according to (13) to (16), further including

a communication unit communicable with an external apparatus, in which

the payment operation includes an operation of bringing the information processing apparatus close to the external apparatus for communicating with the external apparatus.

(18) The information processing apparatus according to (17), in which

the communication unit is capable of performing at least one of communication using a code image or a near field communication (NFC).

(19) An information processing method, including:

by a controller in an information processing apparatus,

generating purchase information on the basis of a payment operation using the information processing apparatus for purchasing a target object of the user;

sending the generated purchase information; and

receiving reward information regarding the reward depending on purchase of the target object, the reward information being generated on the basis of the sent purchase information.

### REFERENCE SIGNS LIST

10 user terminal
14 touch panel
20 sensor unit
21 communication unit
24 clock unit
25 purchase information generating unit
26 purchase information sending unit
27 reward information receiving unit
30 reader/writer
35 POS apparatus
50 server apparatus
58 storage unit
59 communication unit
63 rule information receiving unit
64 purchase information receiving unit
65 reward information generating unit
66 analysis information generating unit
100 user return system

1. An information processing apparatus, comprising:
a receiving unit that receives purchase information generated on a basis of a payment operation using a user terminal for purchasing a target object, from the user terminal; and
a generating unit that generates, on a basis of the received purchase information and predetermined rule information regarding giving of a reward, reward information regarding the reward depending on purchase of the target object.

2. The information processing apparatus according to claim 1, wherein
the payment operation comprises a tap interaction.

3. The information processing apparatus according to claim 1, wherein
the purchase information includes payment information regarding the purchase of the target object.

4. The information processing apparatus according to claim 1, wherein
the purchase information includes at least one of a time at which the payment operation is performed or a position at which the payment operation is performed.

5. The information processing apparatus according to claim 1, wherein
the user terminal is capable of performing at least one of communication using a code image or a near field communication (NFC).

6. The information processing apparatus according to claim 1, further comprising
a sending unit that sends the generated reward information to the user terminal.

7. The information processing apparatus according to claim 1, further comprising
a receiving unit that receives the rule information set by a business operator.

8. The information processing apparatus according to claim 1, wherein
the rule information includes at least one of a target object that is a reward giving target, a purchase amount that is a reward giving target, a purchase period that is a reward giving target, or a purchase position that is a reward giving target.

9. The information processing apparatus according to claim 1, further comprising
a storage unit that stores a history of the received purchase information, wherein
the generating unit generates the reward information on a basis of the stored history of the purchase information.

10. The information processing apparatus according to claim 9, further comprising
a receiving unit that receives the rule information set by a business operator, wherein
the receiving unit receives the rule information at a timing after the history of the purchase information is stored in the storage unit.

11. The information processing apparatus according to claim 1, further comprising
a storage unit that stores a history of the received purchase information, wherein
the generating unit generates analysis information regarding the purchase of the target object on a basis of the stored history of the purchase information.

12. An information processing method, comprising:
by a controller that is an information processing apparatus,
receiving purchase information generated on a basis of a payment operation using a user terminal for purchasing a target object, from the user terminal; and
generating, on a basis of the received purchase information and predetermined rule information regarding giving of a reward, reward information regarding the reward depending on purchase of the target object.

13. An information processing apparatus that is usable by a user, comprising:
a generating unit that generates purchase information on a basis of a payment operation using the information processing apparatus for purchasing a target object of the user;
a sending unit that sends the generated purchase information; and
a receiving unit that receives reward information regarding the reward depending on purchase of the target object, the reward information being generated on a basis of the sent purchase information.

14. The information processing apparatus according to claim 13, wherein
the payment operation comprises a tap interaction.

15. The information processing apparatus according to claim 13, wherein
the purchase information includes payment information regarding the purchase of the target object.

16. The information processing apparatus according to claim 13, further comprising
an obtaining unit that obtains, on a basis of the payment operation, at least one of a time at which the payment operation is performed or a position at which the payment operation is performed, wherein
the purchase information includes the obtained at least one of the time at which the payment operation is performed or the position at which the payment operation is performed.

17. The information processing apparatus according to claim 13, further comprising
a communication unit communicable with an external apparatus, wherein
the payment operation includes an operation of bringing the information processing apparatus close to the external apparatus for communicating with the external apparatus.

18. The information processing apparatus according to claim 17, wherein
the communication unit is capable of performing at least one of communication using a code image or a near field communication (NFC).

19. An information processing method, comprising:
by a controller in an information processing apparatus,
generating purchase information on a basis of a payment operation using the information processing apparatus for purchasing a target object of the user;
sending the generated purchase information; and
receiving reward information regarding the reward depending on purchase of the target object, the reward information being generated on a basis of the sent purchase information.
